(19) United States
(12) Patent Application Publication
(10) Pub. No.: US 2013/0055983 A1
(43) Pub. Date: Mar. 7, 2013

(54) Internal Combustion Energy Recovery, ICER

(71) Applicant: Adrian George Vance, Lakeport, CA (US)

(72) Inventor: Adrian George Vance, Lakeport, CA (US)

(21) Appl. No.: 13/225,291

(22) Filed: Sep. 2, 2011

(51) Int. Cl. F02B 47/02; F02B 75/08

(52) U.S. Cl. 123/25 C; 123/668

(57) ABSTRACT

72% of all energy generated in an internal combustion engine is lost to the radiators and exhaust. Internal Combustion Energy Recovery, ICER, uses this energy by reflecting the infrared, IR, radiation from combustion to capture it with absorbing gas (to) increase cylinder pressure. This technology is adaptable to existing engine(s) as a “bolt on” modification.

### BACKGROUND OF THE INVENTION

The four-cycle internal combustion engine function begins with a fuel and air intake cycle followed by a compression cycle, a power cycle and an exhaust cycle. In each cycle the crankshaft articulating the piston rotates 180 degrees to move the piston down or up for each operation.

We model a cylinder having a swept volume of 500 cubic centimeters, cm³, with the piston at zero degrees, “top dead center.” A 500 cm³ (volume) of fuel/air mixture from the intake cycle has been compressed to a volume of 50 cm³, 1/10^{th} the inducted volume giving it a pressure of ten atmospheres.

The spark plug fires and the fuel air mixture burns rapidly, but not as an explosion. Explosions produce shock waves with velocities greater than 300 meters per second, the speed of sound, compressing air molecules into waves so closely packed molecules are in contact and act as solids.

When shock waves strike cylinder walls “knocking” sounds are heard. This is normal in Diesel engines where combustion is explosive, making the characteristic “Diesel sound.” It is only heard in gasoline engines when the fuel/air mixture explodes prematurely and is called “Dieseling.” That we do not hear such sounds in gasoline engines means combustion advances at less than 300 meters per second, but we assume the combustion velocity is close to that figure as that is the nature of processes approaching physical limits.

300 meters per second is a natural limit known as “the sound barrier.” Energy to exceed such a limit, or barrier, is always on a rapidly rising curve. Thus, we assume the speed of combustion to be at or near 300 meters per second. Experience will refine optimum timing for water injection as well as tell us more about combustion. Timing depends on combustion velocity and it will vary with fuel composition and air quality. Where the chemistry of combustion includes both oxidation and reduction we have opportunities to apply this technology to existing engines.

Combustion heat energy is actually infrared radiation in the 0.5 to 16 mu, micrometer, range. Much of it is absorbed by the cylinder, combustion chamber and piston top finally heating the engine block. In ICER we turn engine cylinders, combustion chambers and piston tops into perfect infrared, IR, reflectors “doing it with mirrors” in the true sense.

In quantum mechanics infrared radiation exists simultaneously as waves and particles with diameters of 10̂12^{th} cm (0.000000000001 cm). This is coincidentally the size of atomic nuclei and electrons as well as the key for our strategy to capture and use energy normally lost.

At the atomic level metal surfaces are not continuous, but granular. Metal atoms are in a structure we can simulate in a ten centimeter cube by filling it with 1,000 one centimeter spheres in ten layers of ten by ten balls. Each ball has a volume of 0.52 cm³. Of the 1,000 cm³ space within the cube the metal balls occupy 520 cm³ of it. 480 cm³ is empty space in “interstitial” voids between the solid balls.

Metals include free electrons in these “interstitia.” Metals are excellent conductors of electricity as these electrons are free to move in the interstitial spaces. They are in places where resistance approaches zero for electrons.

When an electric current passes through metal electrons do not move much. Energy passes through the system like a wave on the sea, but at the speed of light, 300,000 kilometers per second (3.0×10̂5 km/sec) with the electrons little more than vibrating. Free electrons accept infrared energy to express as heat changing host metal temperature. This is the fate of 72% of energy generated in an internal combustion engine. It is wasted.

ICER seeks 100% IR reflectivity in the cylinder, combustion chamber and piston top to retain IR in the cylinder until absorbed by amenable gases expanding them to drive the piston with far greater conversion efficiency, that approaching 100%.

With 100% reflectivity there would be no heat loss. Without a water jacket or fins such an engine at open throttle would be “metal cold” to the touch. The exhaust pipe would be warm, but not hot as nearly all the energy would be turning the crankshaft.

Chromium is our principle reflector, but it requires a base coating of nickel on the aluminum. We further improve chromium reflectivity with a column I metal filling interstitial surface voids between atoms in the surface crystal lattice. Chromium is a particularly amenable element to this strategy given its' unusual outer electron orbital configuration.

Surfaces are formed only by solids and liquids as their atoms and molecules touch. Within metal crystals atoms are surrounded by their own kind held in place by forces of attraction in three dimensions. Surfaces have less than three dimensionality to pack atoms or molecules.

At the atomic level these forces are intense. Gravity is not the weak force we experience on the surface of a planet where it acts through a point, 6450 kilometers away. At the atomic level the force of gravity is 10̂17^{th} (10,000,000,000,000,000) times greater than what we experience. It varies inversely as the square of the distance. And, directly with the density of nuclear matter which is 1×10̂12, one trillion, times that of water in the atomic dimension. Thus, gravity force at the atomic level is incredible.

Where a liquid or solid meets space forces on atoms and molecules are unequal. Surface layers compress as inter-atomic or molecular forces are not opposed by neighbor ranks of atoms or molecules. Water surface density is greater than steel. And so, with a density eight times that of the liquid (water) steel needles float on water. This is a consequence of molecular packing at the boundary where water meets space. It is called “surface tension,” but should be known as “surface packing.” Atoms or molecules shift positions thus filling interstitial spaces quite well on liquid surfaces. And, they have been our best reflectors, but can be improved. We seek to pack surface interstitial spaces with small metal atoms to produce 100%, perfect IR reflectors.

Surfaces are 100% reflecting of electromagnetic radiation if they do not have interstitial voids for waves to enter and be absorbed by rogue free electrons. Where electrons in orbits can only accept certain waves rogue electrons can accept any and convert them to heat.

Solids form surfaces by offsetting and interlacing crystal layers such that atoms enter spaces normally present in a crystal latticework. A packed structure approaches zero empty space between atoms or molecules.

The probability an electromagnetic quanta will strike a bound electron pair and be reflected is great on a surface unless the substance is transparent. Transparency occurs only at angles close to the perpendicular of the surface revealing atomic or molecular geometry determines transparency other than in cases of ionic solids that are amorphous or in frozen liquids like glass(es having great spaces between ions.)

If we plug combustion chamber nanoporosity with atoms it should be possible to make perfect reflectors for trapping IR in the cylinder. But the IR has to be absorbed by a gas for expansion to drive the piston.

Unfortunately: 78% of the gas in the combustion chamber is nitrogen which is transparent to IR, hence no absorption. The only gases absorbing IR are CO₂ and H₂O, water vapor. Molecules of octane burn with oxygen to make CO₂ and H₂O, both absorbers of IR, but with important differences.

The American Meteorological Society chart (FIG. 1) of IR absorption for CO₂ and H₂O shows water vapor IR absorption is much greater in the 0.5 to 16 micrometer (mu) band for IR heat energy there defined by two red vertical lines on either side of the spectra. The absorption area is four times greater for H₂O and wave energy is inversely proportional to the wavelength as graphically illustrated in FIG. 1.

The curve representing the Energy/Wavelength relationship shows that a 0.5 mu wave has 32 times the energy of a 16 mu wave. These are very significant differences when summed in the infinitesimal calculus. By such analyses we find water vapor is about seven times the absorber of IR energy as carbon dioxide, CO₂.

Where octane is the prototype gasoline molecule internal combustion can be modeled as the chemical reaction:

2C₈H₁₈+25O₂=16CO₂+18H₂O

A 500 cm³ fuel/air mixture includes 0.043 g of octane, 0.503 g N₂, 0.116 g O₂ and 0.019 g H₂O vapor. The combustion product will contain 0.629 g of water vapor in the cylinder which does 87% of IR absorption in an engine as CO₂ is such a poor absorber of IR energy.

Adding 12.6 times as much water by injecting 0.77 grams, 16 drops, improves the energy capture situation significantly. Then, IR has a much higher likelihood to be absorbed and expressed as cylinder pressure.

Infrared quanta travel at the speed of light. In this cylinder with the diameter of 8.6 centimeters IR quanta reflect from the walls, top and bottom of the cylinder approximately 500 times during combustion. Fully reflected single quanta ricochet within the cylinder 50,000 times during a full power cycle and thus have very high probability for absorption and conversion to kinetic gas pressure with a water injection. Boosting IR reflection increases kinetic output by reducing the losses to the chamber metal interstitia.

Cylinders and tops of combustion chambers are ordinarily polished to reduce piston friction and facilitate air flow, but they are not plated. Tops of pistons are not now polished. The steps of plating for reflectivity and filling interstitial voids keeps energy in the cylinder for absorption by water vapor molecules to be turned into gas pressure to drive the piston.

This prototype cylinder is “square” having equal cylinder bore and crankshaft stroke, with a journal turning diameter of 8.6 centimeters, cm. This is typical for a four cylinder, two liter, six cylinder three liter, V6 engine or eight cylinder four liter, V8, of the kind used commonly.

Where the spark plug is centrally located combustion is complete after the 300 meter/second reaction traverses the 4.3 centimeter radius of this cylinder. Combustion takes 1.43×10̂-4^{th} seconds, 0.000143 sec. Then we inject 0.77 grams of water. During combustion the crankshaft turns 1.71 degrees. The geometry of the crankshaft/piston system is such that it would move infinitesimally vertically so the combustion chamber volume is very close to 50 cm³ after combustion.

The combustion of 0.043 grams of octane in a 15:1 fuel/air mixture produces 382 calories. Air has a specific heat of 0.239 calories/gram so the 0.646 grams of air in the cylinder could have a post combustion temperature of 2,774 degrees Kelvin if the radiation produced were perfectly contained. This would yield a pressure of 82.4 atmospheres, but where 72% of the heat generated escapes to surrounding metal interstitia we assume a more likely pressure of 23.4 atmospheres in the combustion chamber of existing engines.

The introduction of 0.77 grams of water with infrared reflection from cylinder walls capturing energy normally lost would increase pressure 18.5 atmospheres as it produces 924 cm̂3 of water vapor gas, aka “steam.”

### Excel Model

The first data column (FIG. 2) shows the crankshaft angle in degrees during the power cycle. The crankshaft is straight up at “top dead center,” zero degrees, at the initiation of combustion. The pressure is ten atmospheres as 500 cm³ of fuel/air mixture has been compressed to 50 cm³. We estimate cylinder pressures in atmospheres every 18 degrees or tenth of the cycle. Where power output correlates with cylinder pressure we sum and compare them for analysis.

The model documents a 79% increase in the power output of this engine. This translates to engines half the size of current versions, if they are turbocharged, with a great saving in weight and consequent decrease in fuel used as the engine is the heaviest part of an automobile. Turbocharged engines output 30% more power, but use the same quantity of fuel up to 1 atm. of air boost.

### REFERENCES CITED

The single research paper by the Society of Automotive Engineers is entitled, “Water Injection Effects in a Single Cylinder CFR Engine,” SAE Paper 1999-01-0568 deals exclusively with water injection outside the cylinder during the intake cycle or in the cylinder before the compression cycle. The paper analyzes mixture cooling and knock prevention systems.

There are no published papers on post combustion chamber water injection for power enhancement or IR wave reflection and capture.

### PRIOR ART

### Patents

Water or alcohol solutions have been drawn or injected into internal combustion engines for improved performance with several concepts. In all systems water or a solution has been introduced before combustion with the objective of cooling the mixture to increase density, reduce pre-ignition and production of nitrogen oxides. To wit:
U.S. Pat. No. 4,461,245 to M. Vinokur is for “A method of supplying water to an internal combustion engine for the purpose of allowing operation with leaner fuel mixtures.” Intake manifold pressure is used to control the output of a water pump, thereby making the water injection rate responsive to engine load.
U.S. Pat. No. 4,558,665 assigned to L. Sandbery injects water into the manifold before each intake cycle.
U.S. Pat. No. 4,960,080 to J. O'Neill, E. Schisler, and P. Kubo is for the precombustion addition of water to control of NOx emissions.
U.S. Pat. No. 4,096,829 to G. Spears is for a system to correlate water injection with RPM controlling an atomizer in the intake manifold.
U.S. Pat. No. 4,448,153 to R. Miller is a system for injecting water into a carburetor to allow leaner fuel mixtures. The pump is cycled on and off in response to the parameters of engine temperature, oil pressure and manifold pressure. None are quantitatively defined.
U.S. Pat. No. 5,148,776 to M. J. Connor is a system for coordinating water and fuel injection in the intake manifold. This system uses a computer to calculate fuel/air/water requirements for the engine.
U.S. Pat. No. 5,718,194 to W. Sidney Binion for an internal injection system to introduce “a water mist” during the compression cycle to reduce the temperature of the fuel/air mixture prior to combustion.
U.S. Pat. No. 5,937,799 to Michael J. Connor for an internal combustion engine having water injected directly into the cylinder during the compression stroke to improve the efficiency by cooling the gases.
U.S. Pat. No. 6,289,853 to Thomas J. Walczak for a water injector for injecting a spray or mist of water into the charge air of an internal combustion engine prior to combustion.
U.S. Pat. No. 7,798,119 to Steven J. Keays for an in-cylinder water injector “to input a mist into the chamber to cool the mixture” and “create a water droplet gaseous fuel mixture for combustion.”

No present patent discloses water injected into a combustion chamber during any stage of or after combustion to improve capture of IR, infrared, wave energy. All existing patented systems introduce water in ways that reduce oxygen in the mixture to the degree water vaporizes. None use or modify the spark plug for injection. All call for new generations of engines. ICER can be employed as a “bolt on” improvement for existing engines.

### DESCRIPTION OF THE FIRST EMBODIMENT

The principle component is a modified spark plug (FIG. 3) with a hollow metal tube, pipe, channel or conduit as the center electrode with a backflow trap valve. The fluid channel is very narrow as the amount of water or solution to be injected is very small, 0.77 gram, 16 drops per cycle.

A coil for detecting the spark current surrounds the tube. The spark impulse generates a current in this detector coil which is transmitted to the control operating the pump sending water or solution through the tube to the combustion chamber.

In a cylinder with a swept volume of 500 cm³ we inject 0.77 cm³, 16 drops, of water through the tube immediately after combustion. Timing is critical. Injections may be controlled by the digital processor system that operates intake manifold fuel injectors and ignition timing, as a new task, or with a separate unit, as shown.

While the injection system will improve output of an existing internal combustion engines the system will not exploit space and weight savings or output until specially designed aluminum engines are produced.

Chromium on aluminum plating requires a nickel plated base to achieve a continuous coating on aluminum. Chromium, Cr, is a periodic table curiosity having six oxidation states where most elements have one or two. Most metal atoms have very well-defined electron shell structures, but chromium is an exception, expressing one electron as either a “d” or an “s” electron. It is our hypothesis where this is the normal state of a chromium atom it may form covalent bonds within the crystal matrix with column I atoms that all have a lone “s” electron which will then lock into the atomic interstia to form a perfect IR reflector.

FIG. 4 illustrates the quantum mechanical concept of electron shells: The “s” electrons are in spherical clouds. Chromium has “p,” and “d” electrons in paired balloon-like orbitals on three and five axes, respectively. The “p” electrons have three orbitals for six electrons in three pairs. The “d” orbitals have five axes, and pairs of electrons. Chromium has a “d” orbital with a lone electron. This electron may acquire energy and jump to the next “s” level to surround the entire atom as a “cloud” and apparently does often.

Electrons spin and pair with others turning in opposite directions as electron spin induces an intense magnetic field at the atomic level orienting electrons to one another like small magnets.

At the atomic level forces are billions of times more intense than those we experience. At the level of subatomic particles they are even greater as they are in a dimension with 1/10,000^{th} the parametrics of atoms. There the magnetic force is so great it would flatten a steam locomotive to something a few atoms thick in a microsecond.

In ICER we deposit Column I metal atoms to the interstitials of the chromium surface to produce perfect IR reflectors. Starting with lithium we work through these metals to find which will best put metal atoms into the voids of the chromium crystal lattice work to make more perfect reflectors.

These engines will not need cooling systems and the exhaust will only be warm. All of the energy from combustion will be in the crankshaft. This will miniaturize engines when fully realized so they may be one-quarter their present size. When Hitler asked Dr. Ferdinand Porsche, “Why is the engine in the rear?” Dr. Porsche said, “One day the internal combustion engine will be so small no one will care where it is.” That day is at hand.

### THE SECOND EMBODIMENT

The “Detector” coil could generate sufficient energy, as a transformer secondary, to drive a solenoid injector pump. Timed by a reluctance in the circuit delaying injection such an ICER version would be a low cost “bolt on” accessory with simple electronics and high reliability.

Existing engines will not have internal reflective plating, but there is a way that can be accomplished.

### In Situ Plating

In the laboratory Bunsen burners are adjusted to produce hot oxidizing flames in which the elements lose electrons while making energy. Properly tuned their flames are pale blue in color. If we cut air to a Bunsen flame it turns yellow as atomic carbon is produced by reduction, gaining electrons. These atoms appear as soot, the very fine powder of carbon atoms. Every flame has a reducing zone in the edge burning oxygen. This zone expands as oxygen declines in the cylinder. It is the source of carbon in engines as it is generated in a side reaction of octane combustion.

If metal ions are present during the final combustion stage we can use this fleeting chemistry to plate metal cylinders, heads and piston tops with a plasma of atoms made in engines to increase IR reflectivity.

From solutions of ions metal atoms will be cast out of the combustion. A series of ionic solutions of nickel, chromium and Column I metals should create perfect IR reflectors in existing engines.

Flame reduction plating only requires dilute solutions of metal ions, a shorter interval between ignition spark and injection to inspire the reduction. The rates of plating for each element will vary, but this will be a way for an increase of the output of existing engines as well as offer a low-cost, “bolt on” improvement for the automotive market.

### DESCRIPTION OF THE FIGURES

FIG. 1 The American Meteorological atmospheric IR absorption chart and a graphic representation of the energy/wavelength relationship.

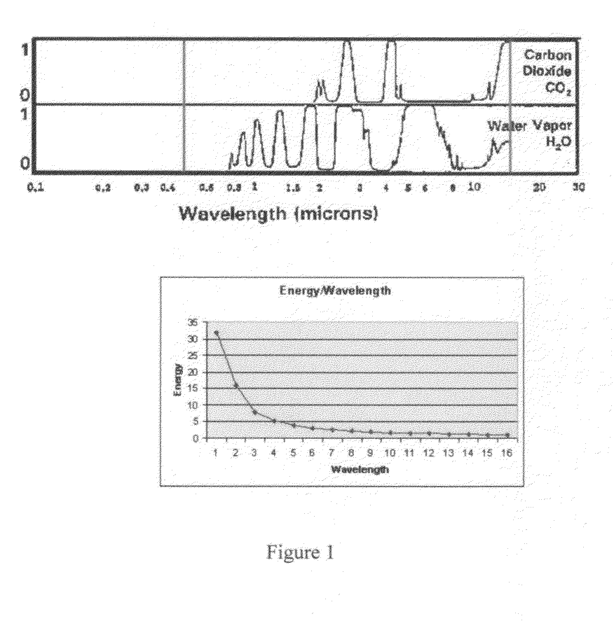

FIG. 2 Excel spreadsheet and graphic analysis of in-cylinder pressures for normal combustion and enhanced with post-combustion water injection.

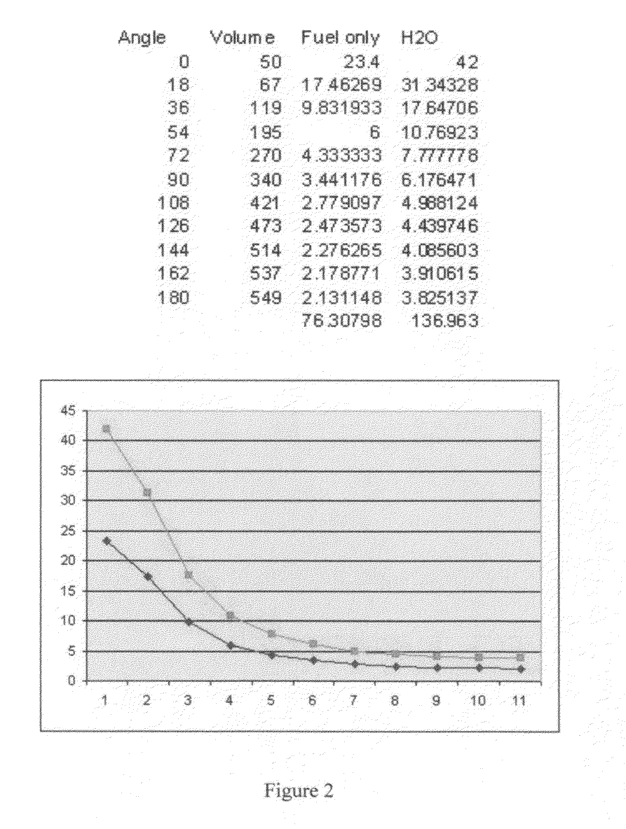

FIG. 3 The ICER injector spark plug with fluid conduit, electric current pulse detector or secondary coil and backflow valve.

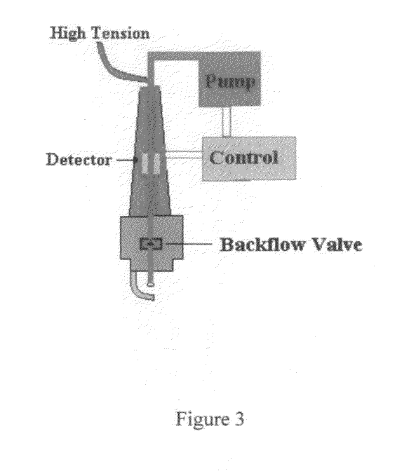

FIG. 4 “s” and “p” electron shell configuration.

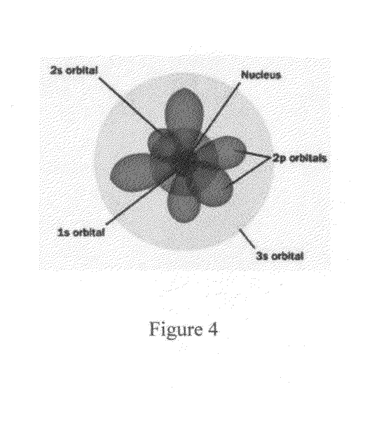

I claim:

1. the method and steps of injecting water into an internal combustion engine through modified spark plugs during or after combustion to capture energy normally lost therein.

2. the method and steps of using the high tension spark impulse firing an internal combustion engine as a signal or energy to inject water during or after combustion.

3. the method and steps of plating internal combustion engine chambers with chromium and a Periodic Table column I metal to reflect and retain infrared radiation generated by said internal combustion.
(a) the method and steps of plating said engine components before assembly and use.
(b) the method and steps of reducing metal ions in the combustion chamber for the purpose of in-situ plating.
